(19) United States
(12) Patent Application Publication
(10) Pub. No.: US 2026/0316660 A1
(43) Pub. Date: Oct. 15, 2026

(54) Apparatus for Enhancing Cargo Tie Down

(71) Applicant: Indigo Industries LLC, Point, TX (US)

(72) Inventor: Ryan Curtis Proctor, Point, TX (US)

(73) Assignee: Indigo Industries LLC, Point, TX (US)

(21) Appl. No.: 19/354,323

(22) Filed: Oct. 9, 2025

Related U.S. Application Data
(60) Provisional application No. 63/721,260, filed on Nov. 15, 2024.

(51) Int. Cl. B60P 7/08; F16C 11/04

(52) U.S. Cl. CPC B60P 7/0823; F16C 11/04

(57) ABSTRACT

A securing strap device for securing cargo during transport, the device according to one embodiment comprising first and second clamping plates, a latching plate, a locking mechanism and stabilizing instruments extending from the second side of the plates. The plates being connected via hinge mechanisms such that when folded and secured around a cargo securing strap the stabilizing instruments push against the cargo and secure the load during transport. The device according to another embodiment comprising first and second clamping plates, a latching mechanism and stabilizing instruments extending from the second side of the plates. The plates being connected via hinge mechanisms such that when folded and secured around a cargo securing strap the stabilizing instruments push against the cargo and secure the load during transport. The invention improves cargo safety, reduces load-shifting damages, and simplifies the process of securing transported goods.

### CROSS REFERENCES TO RELATED APPLICATIONS

This application is related to the following:
i. Provisional Application Ser. No. 63/721,260, filed 15 Nov. 2024 (“Parent Provisional”).

This application claims priority to the Parent Provisional and hereby claims benefit of the filing date thereof pursuant to 37 C.F.R. § 1.78(a).

The subject matter of the Parent Provisional is expressly incorporated herein by reference.

### FIELD OF INVENTION

Embodiments of the present inventions are directed to cargo and freight transportation.

### BACKGROUND

In general, in the descriptions that follow, the first occurrence of each special term of art that should be familiar to those skilled in the art of mechanical engineering, particularly related to clamps and securing straps will be italicized. In addition, when a term that may be new or that may be used in a context that may be new, that term will be set forth in bold and at least one appropriate definition for that term will be provided.

Hereinafter, reference to a captive hinge or double capture hinge shall mean a hinge configuration in which two opposing elements are each hingedly coupled to a common intermediate component that is positioned between them. The intermediate component is rotatably or pivotally mounted to both elements, such that it is captive between the elements and constrained from removal at least in one direction. Reference to a clamp being closed or clamped shall mean my clamp being folded inward, in a nested or stacked position with the latching element engaged such that my clamp is unlikely to open without manually releasing the latching element. Reference to a clamp being open or unclamped shall mean my clamp being substantially unfolded with the latching element being disengaged relative to the latching plate or first clamping plate.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Various tie-down devices, such as straps, ratchets, hooks, anchors, and tensioners, have been developed over the years to address challenges associated with safely securing cargo in trucks, trailers, and other transport platforms. Tie-down accessories play a critical role in assisting with securing loads during transportation, and are vital in preventing damage and shifting of cargo.

As understood by one of ordinary skill in the art, cargo and freight can become loose and unstable even while strapped due to a variety of issues, including, e.g., vibrations and load shifting. This leads to damaged merchandise and safety issues, including injury of persons. Those transporting cargo have to constantly check their loads, manually, for loose straps or shifting cargo. Even with constant supervision, these loads pose a great threat for damaged merchandise, and a liability for the well-being of others' around them. Traditional tie-down systems often rely on fixed anchor points and manual tension mechanisms, which lack versatility, adaptability, or ease of use. With traditional mechanisms, the risk of failure or insufficient tension often leads to cargo displacement, damage and accidents. In particular, there is a special need for securing irregular shaped cargo, such as pipe, furniture, or other non-traditional shaped cargo. These non-traditional shaped cargo often come loose, or cannot be safely secured, with traditional tie down mechanisms. Therefore, there is a need for devices which provide more safety, and securing mechanisms to cargo and freight transportation.

The present invention addresses these challenges by providing a novel cargo tie-down strap clamp that improves load security, user convenience, and versatility across transport vehicles. I developed this invention as a direct result of needing to stop my cargo and freight from becoming loose under the strapping device, causing damage. With fewer straps and tie downs, cargo can be secured at any point on the deck, trailer, boat or other transportation vehicle. Even if a strap becomes loose, the cargo will still abut my clamp thus preventing shifting of the strap relative to the adjacent portion of the cargo. As cargo and freight experience transportation, they are subjected to movement and vibrations. When movement of the cargo and freight happens, they may become poorly secured even after proper tie-down techniques are followed initially. This invention works in conjunction with most tie-down systems to keep movement from causing loads to become unsecured or unstrapped.

### BRIEF SUMMARY OF INVENTION

This invention claims to solve the problem of cargo, freight, and other transported items becoming unsecured, by clamping to strapping, straps, ratcheting tie downs, and other forms of webbing.

According to one embodiment, a clamp, adapted to close around a securing strap, the clamp comprising: a first clamping plate having a first edge and a second edge opposite said first edge; a second clamping plate having a third edge and a fourth edge opposite said third edge; a latching plate having a fifth edge and a sixth edge opposite said fifth edge; a first hinge mechanism adapted to couple rotationally said second edge of said first clamping plate and said third edge of said second clamping plate; a second hinge mechanism adapted to rotationally couple said fourth edge of said second plate and said fifth edge of said latching plate; and a latching mechanism adapted selectively to couple said latching plate to first clamping plate.

According to a different embodiment, A clamp adapted to close around a securing clamp, comprising: a first clamping plate, comprising: a first edge, and a second edge opposite said first edge; a second clamping plate, comprising: a first finger, comprising: a third edge, a fourth edge substantially orthogonal to said third edge, and a fifth edge opposite said third edge; and a second finger, comprising: a sixth edge, a seventh edge substantially orthogonal to said sixth edge, and an eighth edge opposite said sixth edge; and a flange, comprising: a first portion, coupled to said fifth edge of said first finger and extending downward relative to said first finger, a second portion coupled to said eighth edge of said second finger and extending downward relative to said second finger;, and a third portion coupled to said first portion and said second portion such that said first finger and said second finger are substantially coplanar and said third portion extends downward relative to the first finger and the second finger; and a hinge mechanism adapted to couple rotationally said second edge of said first clamping plate and said third edge of said first finger of said second clamping plate and said fifth edge of said second finger of said second clamping plate; and a latching mechanism, adapted selectively to couple said first clamping plate to said second clamping plate.

### BRIEF DESCRIPTION OF DRAWINGS

FIG. 1 illustrates, in diagrammatic form, an open view of one embodiment of my clamp.

FIG. 2 illustrates, in diagrammatic form, a partially hinged view of my clamp.

FIG. 3 illustrates, in diagrammatic form, a partially hinged view of my clamp.

FIG. 4 illustrates, in diagrammatic form, a closed view of my clamp.

FIG. 5 illustrates an exploded view of the locking mechanism of my clamp.

FIG. 6 illustrates, in diagrammatic form, my clamp in use.

FIG. 7 illustrates, in diagrammatic form, an open view of another embodiment of my clamp.

FIG. 8 illustrates, in diagrammatic form, a partially hinged view of my clamp.

FIG. 9 illustrates, in diagrammatic form, a closed view of my clamp.

FIG. 10 illustrates, in diagrammatic form, a partially hinged view of my clamp.

FIG. 11 illustrates, in diagrammatic form, my clamp in use.

### DETAILED DESCRIPTION

In the following detailed description, reference is made to the accompanying drawings which form a part hereof, and in which is shown by way of illustration specific embodiments which may be practiced. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. In view of the foregoing, the following detailed description is not to be taken as limiting the scope of the embodiments or disclosure.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementation described herein. Also, the description is not to be considered as limiting the scope of the implementations described herein.

The terms “first”, “top”, “second”, “bottom”, “left”, “right”, “perpendicular”, etc., are used for convenience and determined as my clamp would normally lay open flat, such that the faces of the plates are parallel to flat ground, and are not intended to otherwise limit the structures described and claimed. The terms “radial”, “radially”, “lateral”, “laterally”, etc., refer to dimensions extending perpendicular to the first or second clamping plates in a flat position having the bottom surface substantially parallel to flat ground, but are not intended to limit the structures described and claimed. The terms “angle”, “rotationally”, “pivotally”, etc., unless otherwise stated refer to rotation about a central axis. The terms “attach”, “attachment”, etc., pertain to a longitudinal engagement between assembled distinct parts of my clamp, which may be attached to each other, or detached from each other.

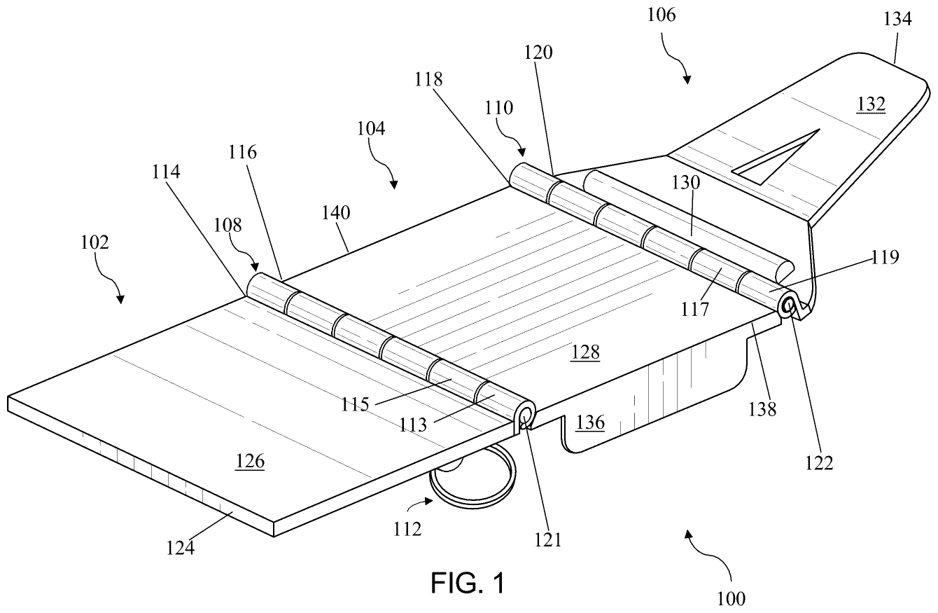

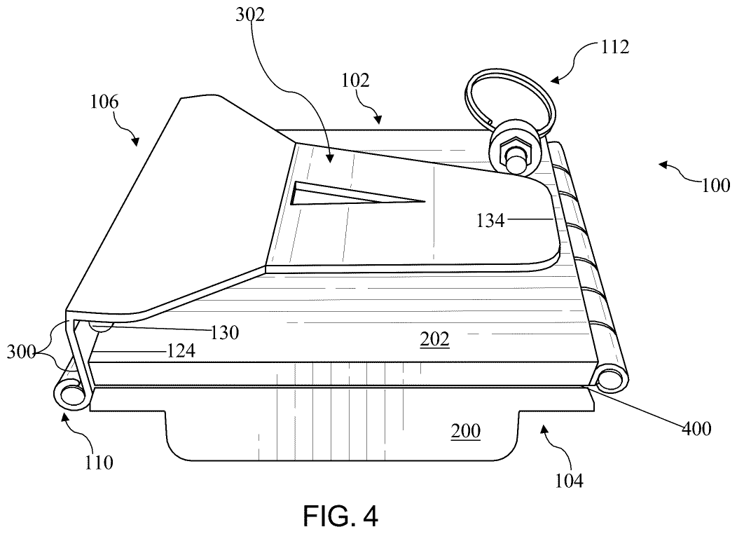

Each of the various embodiments disclosed herein are adapted to provide a quick-release clamp 100 which securely attaches to a securing strap or other similar cargo tie downs, and has flanges, lip(s), prong(s), or other abutment elements which tend to impede slippage of the strap relative to the cargo. According to the embodiment shown in FIG. 1, my clamp 100 is comprised of three plates: a first clamping plate 102; a second clamping plate 104; and a latching plate 106. In this embodiment, the first clamping plate 102 is pivotally-connected to the second clamping plate 104, edge to edge, with a first hinging mechanism 108. Similarly, the latching plate 106 is pivotally-connected to the second clamping plate 104, edge to edge, with a second hinging mechanism 110. My clamp 100 may be held in a closed position (as shown in FIG. 4) via a latching mechanism 112. According to one embodiment, the plates 102, 104 and 106 are machined such that the hinge mechanisms 108 and 110 comprise an integral part of the respective plates. Of course, one of skill in the art would understand that the hinges 108 and 110 do not have to be machined as part of the respective plates, but may be a separate attachment that is affixed onto the respective plates after the plates, per se, have been manufactured.

The hinge mechanisms 108 and 110 may be continuous hinges. The hinge 108 coupling the first clamping plate 102 and the second clamping plate 104 may comprise a first cylindrical portion, or hinge knuckle 113, formed integrally with the edge 114 of the first clamping plate 102, and a second cylindrical portion 115 formed integrally with the edge 116 of the opposing plate 104. Similarly, the hinge 110 coupling second clamping plate 104 and the latching plate 106 may comprise a first cylindrical portion, or hinge knuckle 117 formed integrally with the edge 118 of the second clamping plate 104, and a second cylindrical portion 119 formed integrally with the edge 120 of the latching plate 106. These cylindrical portions 113, 115, 117, 119, are positioned in an interleaved arrangement and aligned to form a continuous cylindrical channel. A hinge pin 121, 122, is inserted through the channel created by the first cylindrical portions 113, 117 and the second cylindrical portions 115, 119, respectively, thereby securing the plates, 102 and 104, 104 and 106, respectively, together while allowing relative rotational movement about a pivot axis. In some embodiments, the hinge pin is welded or fixed in place; in others, it may be removable to allow disassembly. For convenience of reference, a hinge mechanism of this configuration is sometimes referred to as a “piano hinge” or a “continuous hinge”. Although the cylindrical hinge components may be machined as part of the plates, they may alternatively be attached to the plates as secondary components.

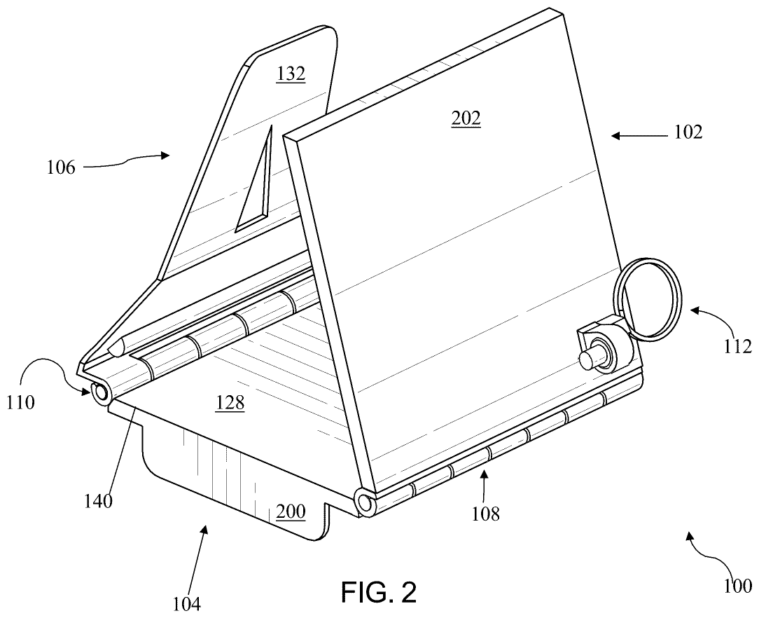

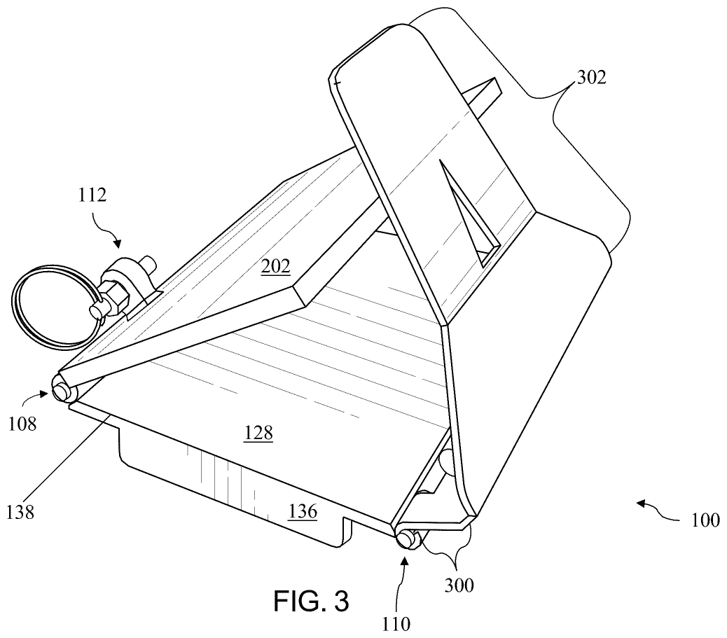

FIGS. 2 and 3 show my clamp 100 with the plates 102, 104 and 106 rotated via the hinging mechanisms 108 and 110 into two possible orientations. As can now be better appreciated, the hinge mechanisms 108 and 110 work in combination such that the plates 102 and 106 can fold inward into a trifold stacked configuration. The first clamping plate 102 should first fold inward toward the second clamping plate 104 such that the first clamping plate 102 lays substantially parallel to the second clamping plate 104. Then, the latching plate 106 can be folded inward toward the first clamping plate 102 such that the latching plate 106 lays substantially parallel to the first clamping plate 102 (as can be seen in FIG. 4).

The second clamping plate 104 has flanges 136 and 200 (see FIGS. 2 and 3) that protrude outwardly from edges 138 and 140, respectively, and substantially perpendicular to the second surface of the plate 104. These pieces may be referred to as a lip, flanges, abutments or other terms for extensions. When in use, the flanges 136 and 200 are adapted to abut an adjacent surface of the cargo or freight to help stabilize the load. One of ordinary skill in the art would understand that these flanges may be machined as part of the second clamping plate 104 or may be a separate attachment that is affixed to the second clamping plate 104 after that plate has been manufactured.

Seen in FIG. 4, my clamp 100 should be oriented such that, when closed, the second surface 202 of the first clamping plate 102 is substantially parallel with the first surface 128 of the second clamping plate 104, while leaving a small gap 400 such that a tie down strap can be compressed within this gap 400. The latching plate 106 can now be closed such that a first surface 132 of the latching plate 106 would meet the second surface 202 of the first clamping plate 102. When fully opened, my clamp 100 resembles a double-hinged “U” where the plates comprising the side portions of the “U” are adapted to rotate inwardly towards the plate comprising the base portion of the “U”. According to one embodiment, as seen in FIGS. 3 and 4, the latching plate 106 is machined such that the first section 300 of the latching plate 106 coupled to the hinge mechanism 110 extends radially away from the second surface 202 of the first clamping plate 102 when in a closed position. The second section 302 of the latching plate 106 is tapered, and angled downward such that the free edge 134 of the latching plate 106 extends to substantially interface with the second surface 202 of the first clamping plate 102 and the latching mechanism 112 when in a closed position. A stiffening bar 130 (also seen in FIG. 1) is placed on the first surface 132 of the latching plate 106 where sections 300 and 302 meet, to press downward on the free edge 124 of the first clamping plate 102 when in a closed position, thereby enhancing the clamping power of the two clamping plates 102 and 104. In one embodiment, the angle of the second section 302 of the latching plate 106 is such that the second section 302 will extend allowing the first surface 123 of the latching plate 106 to hold downward pressure on the second surface 202 of the first clamping plate 102 when in a closed position.

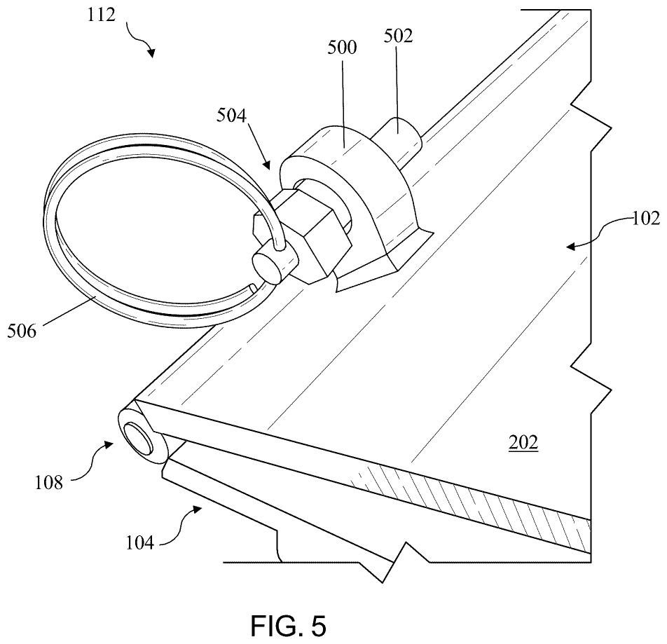

The latching plate 106 is secured down using the latching mechanism 112, such as a lock, clasp or a pin system, as shown in FIGS. 1-6. According to one embodiment, as seen in FIG. 5, a loop 500 is securely attached, such as via welding, to the second surface 202 of the first clamping plate 102. A pin 502 is inserted through the loop and held in place via a spring and lock system 504 (not shown). The ring 506 can be used to pull the pin 502 out to release or disengage the latching mechanism. When latched, or engaged, the pin 502 of the latching mechanism 112 is against the latching plate 106 (not shown in FIG. 5) with my clamp being in a closed or clamped position.

In one embodiment, the latching mechanism 112 comprises a pin and loop structure having a spring-biased detent mechanism 504, retained within or adjacent to the loop 500, adapted continuously to urge the pin towards its locked position. The detent mechanism 504 may consist of a spring-loaded ball, leaf spring, or other resilient element that biases the pin 502 into secure engagement with the loop 500 so as to resist disengagement under vibration or load.

In one version of the latching mechanism 112, the manual release ring 506 is provided on the pin 502 or latch element, allowing a user to manually retract or rotate the pin 502 to disengage it from the loop 500. In other embodiments, this function may be accomplished using, e.g., a lever arm, or a finger tab configured to provide mechanical advantage for disengagement of the latch 112.

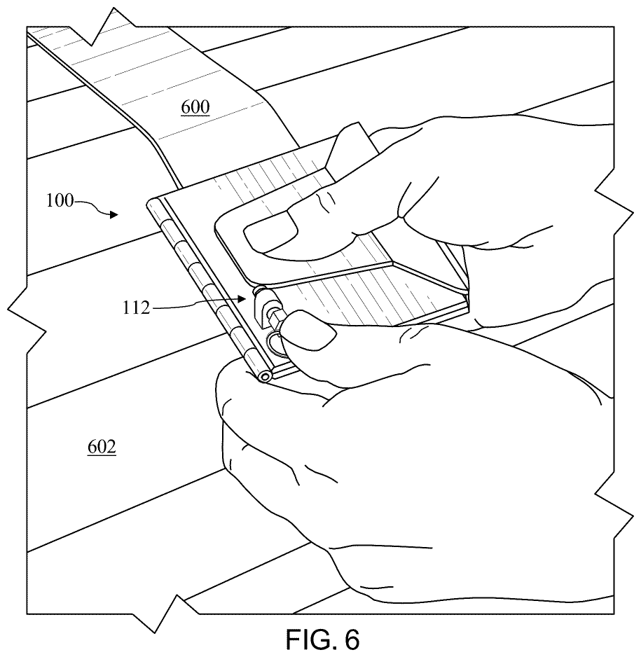

FIG. 6 shows my clamp 100 in use, clamping around a tie down strap 600 and being positioned into close abutment with a selected surface of the cargo 602. My clamp 100 can be easily adjusted and placed according to the needs of the load by disengaging the latching mechanism 112, releasing the latching plate 106, thereby releasing the clamping pressure on the tie down strap 600 and allowing my clamp 100 to slide up or down the tie down strap before being secured again using the latching mechanism 112.

The plates 102, 104 and 106 may be made of metal, plastic or similar materials. According to one embodiment herein, the first and second clamping plates, 102 and 104, respectively, are of the same dimensions. I used stainless steel flat bar, though other metals or plastic would work as well. I cut a 3″ flat bar into two matching pieces 3.5″ long to make the first and second clamping plates 102 and 104, respectively. I then welded them together using a continuous hinge 108, the full distance of the 3.5″ side length, creating a 0.075″ gap 400 between the faces of the plates when closed. I then welded a latching plate 106 to the second clamping plate 104 using another continuous hinge 110, on the edge opposite the first hinge 108. The latching plate 106 is specially designed to extend substantially perpendicular past the first clamping plate 102 opposite the first continuous hinge 108, and bends at a 95 degree angle over the top of the first clamping plate 102. It is designed with a downward tending section 302 which, when closed, comes into contact with the first clamping plate 102 and exerts pressure downward upon it. The profile of the latching plate 106 is of substantially thinner material and of substantially smaller size than my clamping plates 102 and 104. When the latching plate 106 is fully depressed or closed, it interacts with a latch mechanism 112 or clasp, which traps the latching plate 106 in the downward position. After welding these components together, I added flanges 136 and 200 to the two edges 138 and 140, respectively, of the second clamping plate 104 that would typically come into contact with the cargo or freight to provide extra stability. My clamp 100 could be made from a variety of materials including plastic, steel, and stainless steel. It could also be made larger or smaller to account for greater or lesser clamping surface and pressure.

The first and second clamping plates 102 and 104 must work together precisely to correctly clamp strapping material between them without damaging the material. When my clamp 100 is securely clamped to the material abutting a selected edge or surface of the cargo or freight, the cargo or freight will be significantly less likely to shift, slide, or move, even when transport is rough and there are extreme vibrations. The latching plate 106 helps to apply a substantial amount of clamping pressure to the clamping plates 102 and 104 as it has an angled section 302 along its leading edge to allow for maximum clamping pressure without the use of other tools. Once proper position of my clamp 100 has been achieved and the latching plate 106 is fully closed, the latch mechanism 112 will, in general, prevent the clamp 100 from becoming disengaged until acted upon by a person.

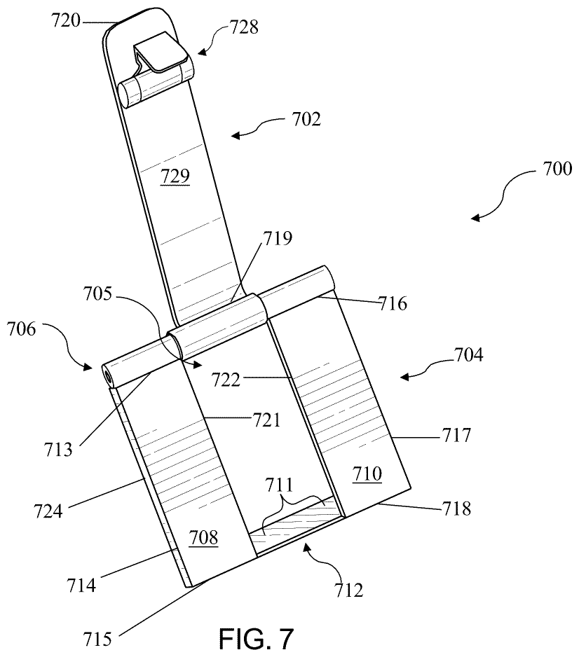

My clamp 700, according to another embodiment herein, is a clamping mechanism comprised of two plates, shown in FIG. 7, namely a first clamping plate 702 and a second clamping plate 704. In this embodiment, the first clamping plate or finger 702 is pivotally connected to the second clamping plate 704, edge to edge, with a hinging mechanism 706. In this embodiment, the second clamping plate 704 is “C” shaped having a first finger 708, a second finger 710 substantially coplanar with the first finger 708, and a structural flange 712 being opposite the hinge mechanism 706. The hinge mechanism 706 may be a captive hinge or double capture, which couples the first edge 713 of the first finger 708 and the first edge 716 of the second finger 710 to the second edge 719 of the first finger 702. The first finger 708 includes a first edge 713, a second edge 714 and a third edge 715(corresponding to the third, fourth, and fifth edges described in the claims respectively). The second finger 710 includes a first edge 716, a second edge 717, and a third edge 718 (corresponding to the sixth, seventh, and eighth edges described in the claims respectively).

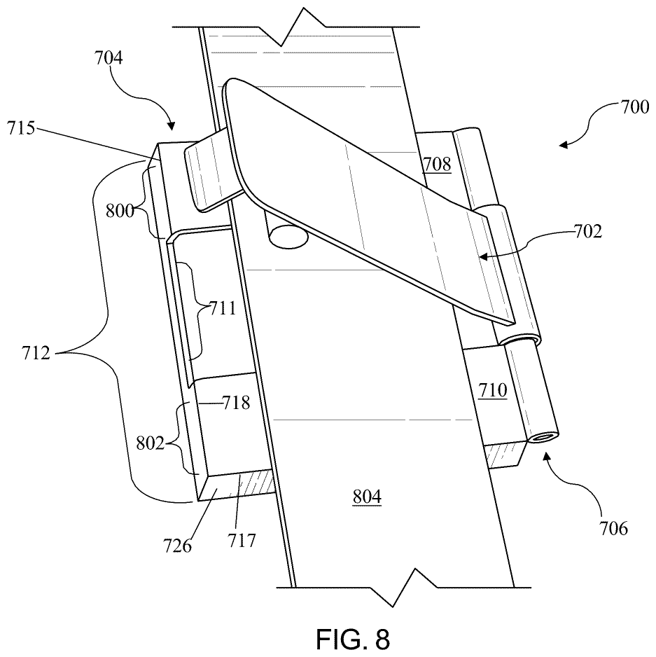

The hinging mechanism 706 allows the plates 702 and 704 to fold towards each other, generally converging around a selected portion of a tie-down 804 (shown in FIG. 8). The plates 702 and 704 may be machined such that the hinge mechanism 706 comprises an integral part of the respective plates. Of course, one of skill in the art would understand that the hinge 706 does not have to be machined as part of the respective plates, but may be a separate attachment that is affixed onto the respective plates after the plates, per se, have been manufactured.

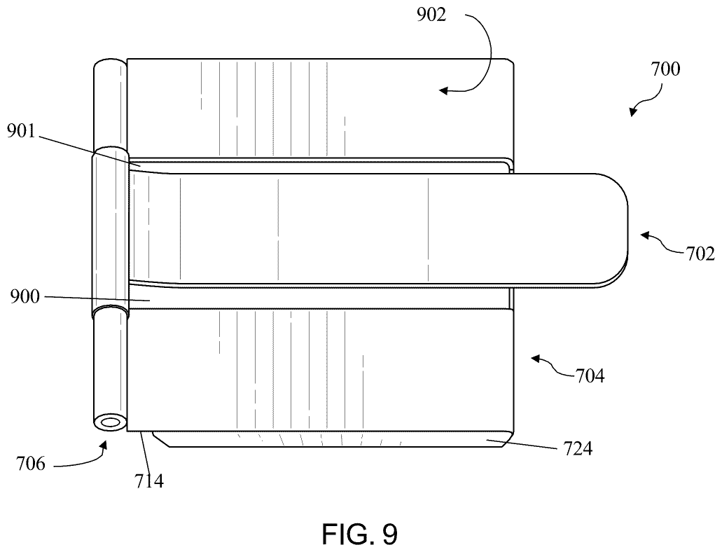

The structural flange 712, couples the third edge 715 of the first finger 708 to the third edge 718 of the second finger 710. According to one embodiment, the second clamping plate 704 is machined such that the structural flange 712 is a part of the plate, namely a curved edge. One of skill in the art would understand that the structural flange 712 does not have to machined as part of the respective plate 704 or fingers 708, 710, but may be a separate attachment that is affixed onto the respective plate 704 after the plate, per se, has been manufactured. In this embodiment, the second clamping plate 704 has two abutment flanges, or abutment structures, 724 and 726 (shown in FIG. 8 and FIG. 9, respectively) extending from the second edge 714 of the first finger 708, and the second edge 717 of the second finger 710, respectively. Although in other embodiments, the second clamping plate 704 may have more or fewer flanges. My clamp 700 may be held in a closed position (shown in FIG. 9) via the latching mechanism 728.

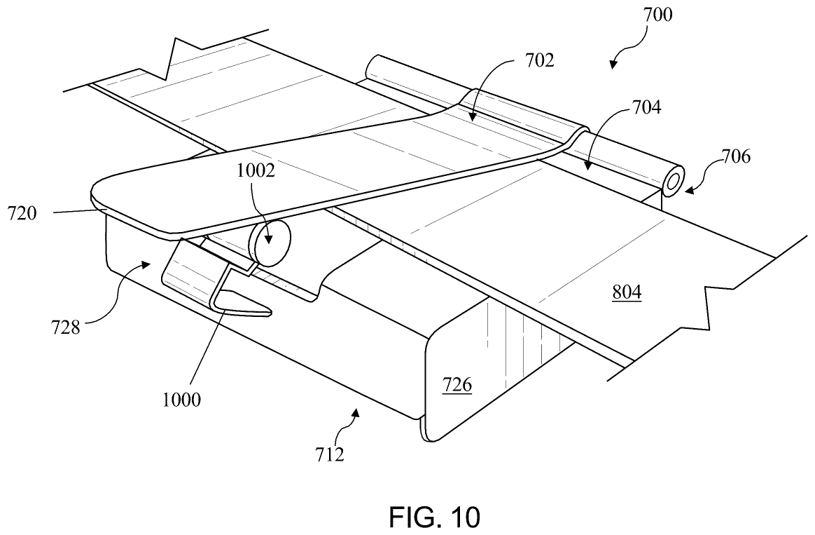

FIGS. 8 and 10 show my clamp 700 with the plates 702 and 704 rotated via the hinging mechanism 706 and into two possible orientations. As can now be better appreciated, the hinge mechanism 706 works such that my clamp 700 can fold inward into a bifold nested configuration. The first clamping plate 702 should fold inward toward the second clamping plate 704 such that the first clamping plate 702 lays substantially parallel to the second clamping plate 704.

As can be seen in FIG. 8 and FIG. 9, the second clamping plate 704 has two abutment flanges 724 and 726, respectively, that protrude outwardly from the second clamping plate 704, and substantially perpendicular relative to the first surface 729 of the first clamping plate 702 when in a closed position (shown in FIG. 9). Although in other embodiments, the second clamping plate 704 may have more or fewer flanges. These pieces may be referred to as a lip, flanges or other stabilizing extensions. When in use, the flanges come into contact with the cargo or freight to help stabilize the load. One of ordinary skill in the art would understand that the flanges may be machined as part of the second clamping plate or may be a separate attachment that is affixed to the second clamping plate 704 after that plate has been manufactured.

According to one embodiment, as seen in FIG. 8, the structural flange 712 is comprised of three sections, namely a latching portion 711, a first finger flange section 800 and a second finger flange section 802 (corresponding to a third portion, a first portion, and second portion described in the claims respectively). The first finger flange section 800 extends from the third edge 715 of the first finger 708 of the second clamping plate 704. The second finger flange section 802 extends from the third edge 718 of the second finger 710 of the second clamping plate 704. The latching portion 711 acts as a structural coupling point or webbing, forming the “c” shape of the second clamping plate. According to one embodiment herein, the latching portion 711 acts as the latching feature for the latching mechanism 728.

According to one embodiment, the gap 705 in the second clamping plate 704 is substantially wider than the width of the first clamping plate 702. As seen in FIG. 9, when my clamp 700 is in the closed position, there are gaps 900 and 902 in the second clamping plate 704, adjacent to the first clamping finger 702. When my clamp 700 is closed around a strap 804, the gaps 900 and 901 provide for enhanced clamping pressure about the strap 804 and tends to prevent slippage of the strap 804.

As shown in FIG. 10, the first clamping plate 702 is secured down in the closed position using a latching mechanism 728 comprising a latch element 1000 such as a lock, clasp or hook, that interacts with the latching portion 711 on the second clamping plate 704. Adjacent to the first edge 720 of the first clamping plate 702, the first clamping plate 702 has a hook, catch, clip or latch 1000 permanently attached thereto via a hinge 1002. When closed, the first clamping finger 702 descends into the gap 705 in the second clamping plate 704. When the first clamping finger 702 is fully closed, the latch element 1000 hooks onto the latching portion 711 of the second clamping plate 704, and tends to prevent my clamp 700 from opening inadvertently. According to one embodiment, the latch element 1000 is securely attached, such as via welding, to the first surface 729 of the first clamping plate 702. The latch element 1000 is adapted selectively to rotate around a pin (not shown), generally between a first, engaged position or a second, disengaged position. When closing and locking, or engaging the latching mechanism 728, the latch element 1000 slides over the curved edge 712 of the second clamping plate 704. The latch element 1000 then securely clasps to the latching portion 711 of the second clamping plate 704. To disengage or open this embodiment of my clamp 700, the latch element 1000 can be pushed back from the distal end using pressure to allow the release and rotation of the latch element 1000 about the pin, via the hinge 1002. One of ordinary skill in the art would understand, while one embodiment here depicts the latching element 1000 connecting to the second clamping plate 704 via the latching portion 711, the latching element 1000 may also connect to the second clamping plate 704 via a notch, structural lip, loop or other receiving system on the second clamping plate 704.

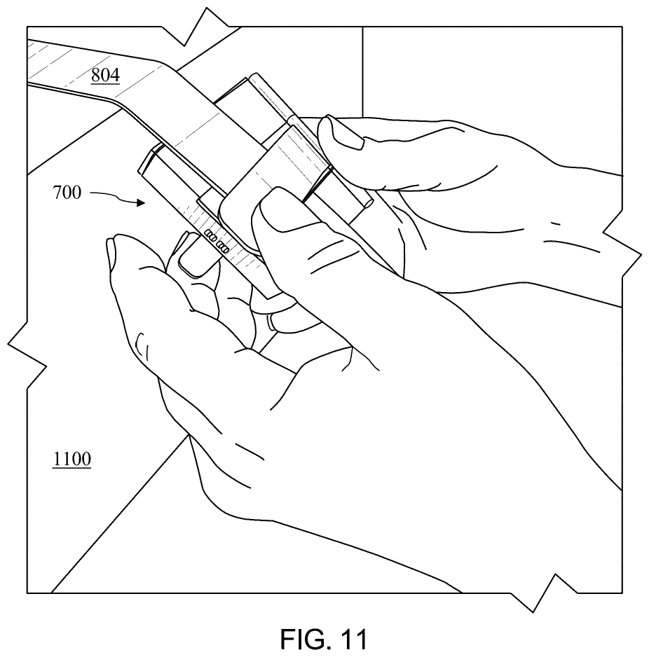

FIG. 11 shows my clamp 700 in use clamping around a selected portion of a tie down strap 804. My clamp 700 should be placed such that the flanges 724 and 726 would abut or push against the cargo 1100. My clamp 700 should be placed such that, when closed, strap 804 should fit snuggly between the first surfaces 729 and 902 of the first and second clamping plates, 702 and 704 respectively, and is securely held in the gaps 900 and 901 by the pressure of the first clamping plate 702 when the latching mechanism 728 is engaged. When fully opened, my clamp 700 looks like a single, hinged device where the side pieces can be rotated towards each other.

I built this embodiment of my clamp 700 using a small piece of 14 gauge stainless steel sheet. I used a sheet metal brake to bend the structural lip and flanges right into the second clamping plate 704. The flanges 724 and 726 are bent downward from the second clamping plate 704, generally at 90 degrees along three edges of the plate 704, and are roughly 0.75″ tall. I then cut the center of the second clamping plate 704 out 1″ wide, from the structural lip 712 to the edge opposite the structural lip 712. I then welded a hinge 706 onto the first clamping plate 702, to which I then welded the second clamping plate 704 such that, when hinged closed, the first clamping plate substantially fills the 1″ gap 705 in the second clamping plate 704. To the free end 720 the first clamping plate 702, I attached a latch 1000 that hooked on the structural lip 712 of the second clamping plate 704 when the first clamping plate 702 is in the closed position. After the fabrication, I sandblasted the pieces that come into contact with the strapping material to increase the friction they exerted.

In one embodiment, the second clamping plate 704 receives the first clamping plate 702 precisely with the strapping material 804 clamped securely between them. When my clamp 700 is securely clamped to the strapping material 804 and, simultaneously, in abutting contact with the cargo or freight, the cargo or freight will substantially be unable to shift, slide, or move, even when transport is rough and there are extreme vibrations. My clamp 700, is designed to be latched into a place on the tie-down strap selected by the user, and is held in place by the pressure of my clamp 700 against the selected portion of the strap 804. When latched, the first clamping plate 702 may tend to be slightly bowed towards the second clamping plate 704, and, therefore, is intentionally made to be slightly flexible so as to apply maximum friction to the strapping material.

My clamp 700 should be used such that, first a person would strap cargo down with tied-down straps or ratcheting straps as needed. They would then place one of my clamps 100 or 700 over the tightened or semi-tightened strap, and slide it up, snug, against the cargo. Depending on which version they choose to use, they would depress the latching plate 102 (clamp 100) or first clamping plate 702 (clamp 700), and latch in place with the pin, clip or clasp 112 (clamp 100) or 728 (clamp 700), thus keeping it tight against the cargo or freight. Insofar as I am presently aware, my clamps 100 and 700 work with all conventional tie-downs and ratcheting straps to improve the security of all cargo and freight. Either also allows items to be secured with less strapping pressure, thereby potentially minimizing damage to items from over-tightening the strapping system. My clamps also help, generally, to minimize the problems caused by human error and overconfidence while securing loads.

With fewer straps and tie-downs, cargo and freight can be secured at almost any point of the deck/trailer/box/boat/etc. Even if a tie-down happens to loosen during transport, the cargo or freight will still abut against my clamp, thus tending to prevent shifting.

The plates may be formed of the same or different materials, including metal, plastic, or composite materials. In certain embodiments, the latching plate is manufactured to be thinner or more flexible than the first and second clamping plates, 102 and 104, respectively, allowing it to deflect and apply pressure to the first clamping plate in the closed position. The geometry of the latching plate or first clamping plate may include bends, tapers, or lobes to increase leverage and ensure consistent force distribution across my clamped strap.

Apparatus, methods, and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods, and apparatus described herein, one of ordinary skill in the art will appreciate that implementations can be made for other fields of art, systems, apparatus, or methods that provide the required functions. The invention should therefore not be limited by the above-described embodiments, methods, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill int eh art will readily recognize that embodiments are applicable to future systems, future apparatus, future methods and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein. Terminology used in the present disclosure is intended to include all environments and alternate technologies that provide the same functionality described herein.

1. A clamp, adapted to close around a securing strap, the clamp comprising:
a first clamping plate having a first edge and a second edge opposite said first edge;
a second clamping plate having a third edge and a fourth edge opposite said third edge;
a latching plate having a fifth edge and a sixth edge opposite said fifth edge;
a first hinge mechanism adapted to couple rotationally said second edge of said first clamping plate and said third edge of said second clamping plate;
a second hinge mechanism adapted to rotationally couple said fourth edge of said second plate and said fifth edge of said latching plate; and
a latching mechanism adapted selectively to couple said latching plate to first clamping plate.

2. The clamp of claim 1, wherein second clamping plate is further characterized as comprising a first surface and a second surface, said second surface comprising at least one of a flange extending radially from the second surface and substantially perpendicular to the third and fourth edges.

3. The clamp of claim 1, wherein the latching plate is further characterized as comprising an angled geometry.

4. The clamp of claim 1, wherein the latching plate is further characterized to be adapted to be configured in a selected one of an open position and a closed position.

5. The clamp of claim 1, wherein the latching mechanism comprises:
a pin configured to be movable between an engaged position and a disengaged position;
a loop configured to receive the pin and being integrally formed with the second surface of the first clamping plate; and
a locking feature comprising a spring-biased detent that retains the pin in the engaged position.

6. The latching mechanism of claim 5, wherein said engaged position comprises the pin extending through the loop to restrict movement of said latching plate when the first clamping plate and the latching plate are hinged into the second clamping plate.

7. The clamp of claim 1, said first hinge mechanism comprises a continuous hinge.

8. The clamp of claim 1, said second hinge mechanism comprises a continuous hinge.

9. The clamp of claim 1, wherein the first clamping plate, second clamping plate and latching plate are further characterized as comprising a selected one of metal and plastic.

10. The clamp of claim 1, wherein the latching plate is further characterized as being substantially thinner than the first and second clamping plates.

11. The clamp of claim 1, whereby, when in a closed position, the latching plate operatively applies a downward pressure to the second surface of the first clamping plate when in a closed position.

12. A clamp adapted to close around a securing clamp, comprising:
a first clamping plate, comprising:
a first edge;
and a second edge opposite said first edge;
a second clamping plate, comprising:
a first finger, comprising:
a third edge;
a fourth edge substantially orthogonal to said third edge; and
a fifth edge opposite said third edge; and
a second finger, comprising:
a sixth edge;
a seventh edge substantially orthogonal to said sixth edge; and
an eighth edge opposite said sixth edge; and
a flange, comprising:
a first portion, coupled to said fifth edge of said first finger and extending downward relative to said first finger;
a second portion coupled to said eighth edge of said second finger and extending downward relative to said second finger;
and a third portion coupled to said first portion and said second portion such that said first finger and said second finger are substantially coplanar and said third portion extends downward relative to the first finger and the second finger; and
a hinge mechanism adapted to couple rotationally said second edge of said first clamping plate and said third edge of said first finger of said second clamping plate and said fifth edge of said second finger of said second clamping plate; and
a latching mechanism, adapted selectively to couple said first clamping plate to said second clamping plate.

13. The clamp of claim 12, wherein the flange is further characterized as being curved, to facilitate latching of the latching mechanism.

14. The clamp of claim 12, wherein the second clamping plate is configured to have at least one of an abutting structure extending radially and substantially perpendicular to the fourth edge of the first finger and the seventh edge of the second finger, such that one or more of the abutting structures abut a portion of a cargo surface.

15. The clamp of claim 12, wherein the second clamping plate is configured to have a central gap extending from the hinged edge of the second clamping plate to the flange of the second clamping plate, and being adapted to receive the first clamping plate.

16. The of clamp 12, wherein the first clamping plate is machined to have a width substantially smaller than that of the gap in the second clamping plate, and being adapted to fit within the gap of the second clamping plate in the closed position.

17. The clamp of claim 12, wherein the latching mechanism comprises:
a latch element secured at the distal end of the first clamping plate opposite said second edge; and
a latching feature at the distal end of the flange of the second clamping plate, the latch element being configured to engage the latching feature by flexing or deflecting over the latching feature and returning to a locked position.

18. The latching mechanism of claim 17, further comprising a manual release tab or portion on the latch element to facilitate disengagement of the latch from the receiving feature.

19. The clamp of claim 12, said hinge mechanism comprises a captive hinge.

20. The clamp of claim 12, wherein the first clamping plate and second clamping plate further characterized as comprising a selected one of metal and plastic.
